(19) United States
(12) Patent Application Publication
(10) Pub. No.: US 2025/0020921 A1
(43) Pub. Date: Jan. 16, 2025

(54) GLOBAL COLOR CORRECTION FOR OPTICAL SYSTEM

(71) Applicant: Applied Materials, Inc., Santa Clara, CA (US)

(72) Inventors: Jinxin FU, Fremont, CA (US); Sihui HE, Santa Clara, CA (US)

(21) Appl. No.: 18/769,069

(22) Filed: Jul. 10, 2024

Related U.S. Application Data
(60) Provisional application No. 63/526,885, filed on Jul. 14, 2023.

(51) Int. Cl. G02B 27/01

(52) U.S. Cl. CPC G02B 27/0101; G02B 2027/0112

(57) ABSTRACT

Embodiments described herein relate to an augmented reality (AR) system. The AR system includes a projection system and an optical device. The projection system includes a backlight, a lens, and an illumination system. The illumination system is configured to receive light from the backlight and emit light having a first color trend. The light having a first color trend is emitted through the lens towards the optical device. The optical device is configured to form a second color trend. The second color trend is opposite the first color trend.

### CROSS-REFERENCE TO RELATED APPLICATIONS

This application claims benefit of U.S. provisional patent application Ser. No. 63/603,545, filed Nov. 28, 2023 and U.S. provisional patent application Ser. No. 63/526,885, filed Jul. 14, 2023. Each of which are herein incorporated by reference.

### BACKGROUND

### Field

Embodiments of the present disclosure generally relate to an optical system. More specifically, embodiments described herein provide an optical system having a projector configured to reduce color non-uniformity in augmented reality applications.

### Description of the Related Art

Optical systems used for imaging or as light engines are common in the art. The optical systems have many different applications, such as capturing images (e.g., in cameras or scanners) or for use in augmented reality/virtual reality applications. The optical systems generally include multiples lenses (e.g., simple lenses, composite lenses, etc.) and films, in order to reduce aberrations caused by imperfections in the lenses.

In diffractive augmented reality (AR) applications, AR waveguides conventionally suffer from color non-uniformity. One limiting factor that produces color non-uniformity is the dispersion of the diffractive element. The limited physical design space of the diffraction waveguide hinders that ability of the waveguide to reduce color non-uniformities.

Conventional optical systems attempt to reduce color non-uniformity by optimizing grating depths, duty cycle, refractive index, and/or coatings, creating more complex designs. Therefore, there is a need for an apparatus and method that can reduce color non-uniformity while also simplifying fabrication.

### SUMMARY

In one embodiment, a projection system is disclosed. The projection system includes a backlight, a lens, and an illumination system. The illumination system is configured to receive light from the backlight and emit light having a first color trend. The light having the first color trend is emitted through the lens towards an optical device. The first color trend at least partially cancels out a second color trend of the optical device.

In another embodiment, an augmented reality (AR) system is disclosed. The AR system includes a projection system and an optical device. The projection system includes a backlight, a lens, and an illumination system. The illumination system is configured to receive light from the backlight and emit light having a first dispersion of light. The light having a first dispersion is emitted through the lens towards the optical device. The optical device is configured to form a second dispersion of light. The first dispersion of light at least partially cancels out the second dispersion of light.

In yet another embodiment, a method of using an augmented reality system having a projection system is disclosed. The method includes emitting a light from a light source toward an illumination system of the projection system. The light emitted from the light source forms, at the illumination system, light having a first color trend. The light having the first color trend is outputted from the illumination system toward an optical device. The first color trend is propagated through the optical device having a second color trend to form a propagated light. The propagated light is outputted from the optical device toward a user's eye.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only exemplary embodiments and are therefore not to be considered limiting of its scope, for the disclosure may admit to other equally effective embodiments.

FIG. 1A illustrates a perspective, frontal view of a substrate, according to embodiments described herein.

FIG. 1B is a perspective, frontal view of an optical device, according to embodiments described herein.

FIG. 2 illustrates a schematic, side view of a projection system including a liquid crystal on silicon (LCOS) illumination engine, according to embodiments described herein.

FIG. 3 illustrates a schematic, side view of a projection system including a digital light processing (DLP) system, according to embodiments described herein.

FIG. 4A illustrates a projection system with modified micro-light emitting diode (uLED), according to embodiments described herein.

FIG. 4B illustrates a fourth modified pixel, according to embodiments described herein.

FIG. 4C illustrates a fifth modified pixel, according to embodiments described herein.

FIG. 4D illustrates a sixth modified pixel, according to embodiments described herein.

FIG. 4E illustrates a seventh modified pixel, according to embodiments described herein.

FIG. 5A illustrates a projection system with a micro-lens array (MLA) system, according to embodiments described herein.

FIG. 5B illustrates a projection system with the MLA system, a first MLA lens and a second MLA lens, according to embodiments described herein.

FIG. 5C illustrates a projection system with the MLA system, a first LED lens, a second LED lens, and a MLA lens, according to embodiments described herein.

FIG. 5D illustrates a projection system with a mixing rod system, according to embodiments described herein.

FIG. 6 illustrates a projection system with a mini-LED system having an LCOS illumination engine, according to embodiments described herein.

FIG. 7 illustrates a projection system with a mini-LED system having a DLP system, according to embodiments described herein.

FIG. 8 illustrates a method of using projection system, according to embodiments.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

The present disclosure generally relates to an optical system. More specifically, embodiments described herein provide an optical system having a projector configured to reduce color non-uniformity in augmented reality applications.

The techniques described herein include an augmented reality (AR) system. The AR system includes a projection system and an optical device. The projection system includes a backlight, a lens, and an illumination system. The illumination system is configured to receive light from the backlight and emit light having a first color trend. The light having a first color trend is emitted through the lens towards the optical device. The optical device is configured to form a second color trend. The second color trend is at least partially canceled out by the first color trend. A method of using the AR system includes emitting a light from a light source toward an illumination system of the projection system. The light emitted from the light source forms, at the illumination system, light having a first color trend. The light having the first color trend is outputted from the illumination system toward an optical device. The first color trend is propagated through the optical device having a second color trend to form a propagated light. The propagated light is outputted from the optical device toward a user's eye.

One challenge encountered when measuring optical devices for image quality is the presence of color non-uniformity (e.g., an image from a RGB backlight that is propagated through the optical device may have a color trend that is bluish on one side and reddish on the other side). One source of color non-uniformity is the dispersion of the diffractive element of the optical device. The optical device, such as a diffractive waveguide, has limited design space within which such issues can be corrected or mitigated. Optimizing grating depths, duty cycle, refractive index, or coatings, or creating more complex grating designs, are insufficient to achieve the color uniformity desired. Further, as there is typically a tradeoff between color uniformity and efficiency in an optical device, optical device design aimed at reducing color non-uniformity may decrease the efficiency of the diffraction optical device.

Accordingly, various embodiments of this disclosure alter the light emitted toward the optical device prior to the interaction with the optical device in order to use the inherent properties of the optical device to reduce the color non-uniformity.

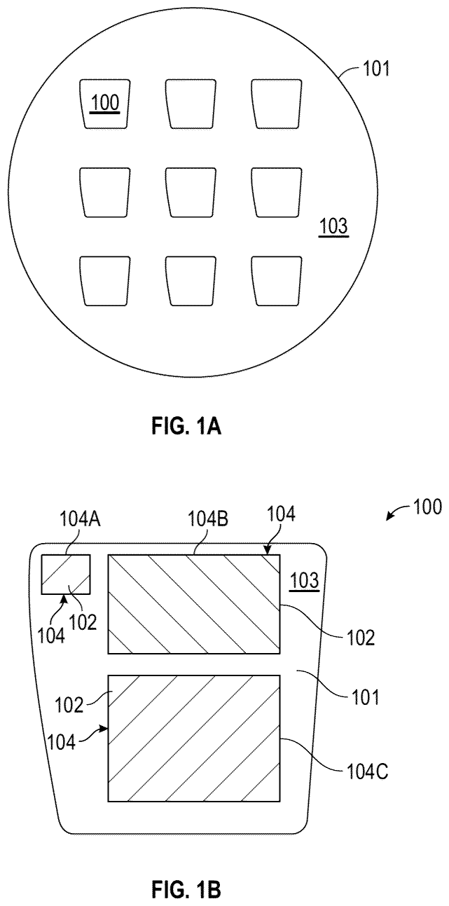

FIG. 1A is a perspective, frontal view of a substrate 101. The substrate includes a plurality of optical devices 100 disposed on a surface 103 of the substrate 101. In some embodiments, which can be combined with other embodiments described herein, the optical devices 100 are waveguide combiners utilized for virtual, augmented, or mixed reality. In some embodiments, which can be combined with other embodiments described herein, the optical devices 100 are flat optical devices, such as metasurfaces.

The substrate 101 can be any substrate used in the art, and can be either opaque or transparent to a chosen wavelength of light, depending on the use of the substrate 101. The substrate 101 includes, but is not limited to, silicon (Si), silicon dioxide (SiO₂), fused silica, quartz, silicon carbide (SiC), germanium (Ge), silicon germanium (SiGe), indium phosphide (InP), gallium arsenide (GaAs), gallium nitride (GaN), silicon nitride (SiN), or sapphire containing materials. Additionally, the substrate 101 may have varying shapes, thicknesses, and diameters. For example, the substrate 101 may have a diameter of about 150 mm to about 300 mm. The substrate 101 may have a circular, rectangular, or square shape. The substrate 101 may have a thickness of between about 300 μm to about 1 mm. Although only nine optical devices 100 are shown on the substrate 101, any number of optical devices 100 may be disposed on the surface 103 of the substrate 101.

FIG. 1B is a perspective, frontal view of an optical device 100. It is to be understood that the optical devices 100 described herein are exemplary optical devices and that other optical devices may be used with, or modified to perform, aspects of the present disclosure. The optical device 100 includes a plurality of optical device structures 102 disposed on a surface 103 of a substrate 101. The optical device structures 102 may be nanostructures having sub-micron dimensions, e.g., nano-sized dimensions. Regions of the optical device structures 102 correspond to one or more gratings 104, such as a first grating 104a, a second grating 104b, and a third grating 104c. In one embodiment, which can be combined with other embodiments described herein, the optical device 100 includes at least the first grating 104a corresponding to an input coupling grating and the third grating 104c corresponding to an output coupling grating. In another embodiment, which can be combined with other embodiments described herein, the optical device 100 also includes the second grating 104b corresponding to an intermediate grating. The optical device structures 102 may be angled or binary. The optical device structures 102 may have other cross-sections including, but not limited to, circular, triangular, elliptical, regular polygonal, irregular polygonal, and/or irregular shaped cross-sections.

In operation, the first grating 104a receives incident beams of light having an intensity from a light engine. The incident beams are split by the optical device structures 102 into T1 beams that have all of the intensity of the incident beams in order to direct a virtual image to the intermediate grating (if utilized) or to the third grating 104c. In one embodiment, which can be combined with other embodiments described herein, the T1 beams undergo total-internal-reflection (TIR) through the optical device 100 until the T1 beams come in contact with the optical device structures 102 of the intermediate grating. The optical device structures 102 of the intermediate grating diffract the T1 beams to T1 beams that undergo TIR through the optical device 100 to the optical device structures 102 of the third grating 104c. The optical device structures 102 of the third grating 104c outcouple the T1 beams to the user's eye. The T1 beams outcoupled to the user's eye display the virtual image produced from the light engine from the user's perspective and further increase the viewing angle from which the user can view the virtual image. In another embodiment, which can be combined with other embodiments described herein, the T1 beams undergo total-internal-reflection (TIR) through the optical device 100 until the T1 beams come in contact with the optical device structures 102 of the third grating 104c and are outcoupled to display the virtual image produced from the light engine.

To ensure that the optical devices 100 meet image quality standards, metrology metrics of the fabricated optical devices 100 must be obtained. The metrology metrics of each optical device 100 are tested to ensure that pre-determined values are achieved. Embodiments of the measurement system 200 described herein provide for the ability to obtain multiple metrology metrics with increased throughput. The metrology metrics include one or more of an angular uniformity metric, a contrast metric, an efficiency metric, a color uniformity metric, a modulation transfer function (MTF) metric, a field of view (FOV) metric, a ghost image metric, and an eye box metric.

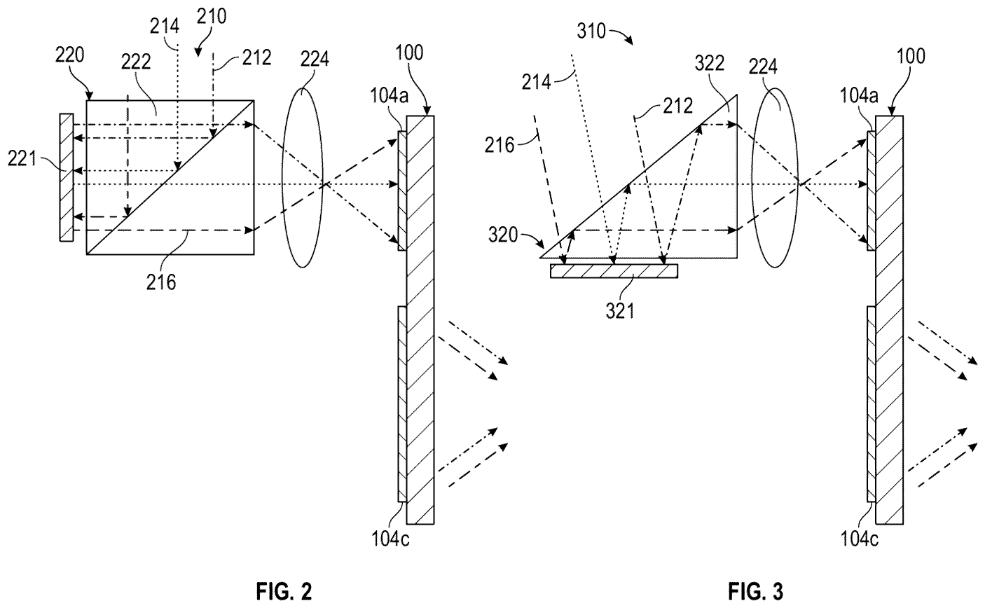

FIG. 2 illustrates a schematic, side view of a projection system 210 including a liquid crystal on silicon (LCOS) illumination engine 220. The projection system 210 may be part of an augmented reality (AR) system or a virtual reality (VR) system. The projection system 210 includes a light source, such as a RGB backlight (not shown), a lens 224, and the LCOS illumination engine 220. The RGB backlight is configured to emit visible light (e.g., red light 212, green light 214, and blue light 216). In some embodiments, the RGB backlight may include one or more light emitting diodes (LEDs). The LED may include a red LED, a green LED, and blue LED. The red LED produces the red light 212, the green LED produces the green light 214, and the blue LED produces the blue light 216. The lens 224 is positioned between the LCOS illumination engine 220 and an optical device 100.

The LCOS illumination engine 220 includes a LCOS 221 and a beam splitter 222. The LCOS illumination engine 220 is configured to pre-compensate for a color trend (e.g., the second color trend) of the optical device 100 in order to reduce the color non-uniformity. The second color trend corresponds to a second dispersion of the light by the optical device 100. The light (e.g., the red light 212, the green light 214, and the blue light 216) emitted from RGB backlight may be adjusted (i.e., a first dispersion of light) by the LCOS 221 to form a first color trend. By adjusting the RGB backlight position, RGB backlight size, lens 224 position, and the lens 224 size, the LCOS illumination engine 220 may further form the first color trend. The RGB backlight emits the light towards the beam splitter 222 of the LCOS illumination engine 220. The beam splitter 222 splits or isolates the red light 212, the green light 214, and the blue light 216. The split or isolated red light 212, green light 214, and blue light 216 are directed towards the LCOS 221 to form the first color trend. The light of the first color trend is directed from the LCOS 221 towards the lens 224, which is configured to focus the light of the first color trend towards the optical device 100. The first color trend may have, for example, more red light 212 on one side of the first trend and more blue light 216 on an opposite side of the first trend. The first color trend of the LCOS illumination engine 220 may be the inverse or opposite of the second color trend of the optical device 100, thereby compensating for the global color shift of the optical device 100.

FIG. 3 illustrates a schematic, side view of a projection system 310 including a digital light processing (DLP) system 320. The projection system 310 may be part of an augmented reality (AR) system or a virtual reality (VR) system. The projection system 310 includes a light source, such as a RGB backlight (not shown), a lens 224, and the DLP system 320. The RGB backlight is configured to emit visible light (e.g., red light 212, green light 214, and blue light 216). In some embodiments, the RGB backlight may include one or more LEDs. The LED(s) may include a red LED, a green LED, and blue LED. The lens 224 may be positioned between the DLP 321 and an optical device 100.

The DLP system 320 includes a DLP 321 and a beam splitter 322. The DLP system 320 is configured to pre-compensate for a second color trend of the optical device 100 in order to reduce color non-uniformity. The second color trend corresponds to a second dispersion of the light by the optical device 100. The light (e.g., the red light 212, the green light 214, and the blue light 216) emitted from RGB backlight may be adjusted (i.e., a first dispersion of light) by the DLP 321 to form a first color trend. By adjusting the RGB backlight position, RGB backlight size, lens 224 position, and the lens 224 size, the DLP system 320 may further form the first color trend. The RGB backlight emits the light towards the beam splitter 322 of the DLP system 320. The beam splitter 322 splits or isolates the red light 212, the green light 214, and the blue light 216. The split or isolated red light 212, green light 214, and blue light 216 are directed towards the DLP 321 to form the first color trend. The light of the first color trend are directed towards the lens 224, which is configured to focus the light of the first color trend towards the optical device 100. The first color trend of the DLP system 320 may be the inverse of a second color trend of the optical device 100, thereby compensating for the global color shift of the optical device 100.

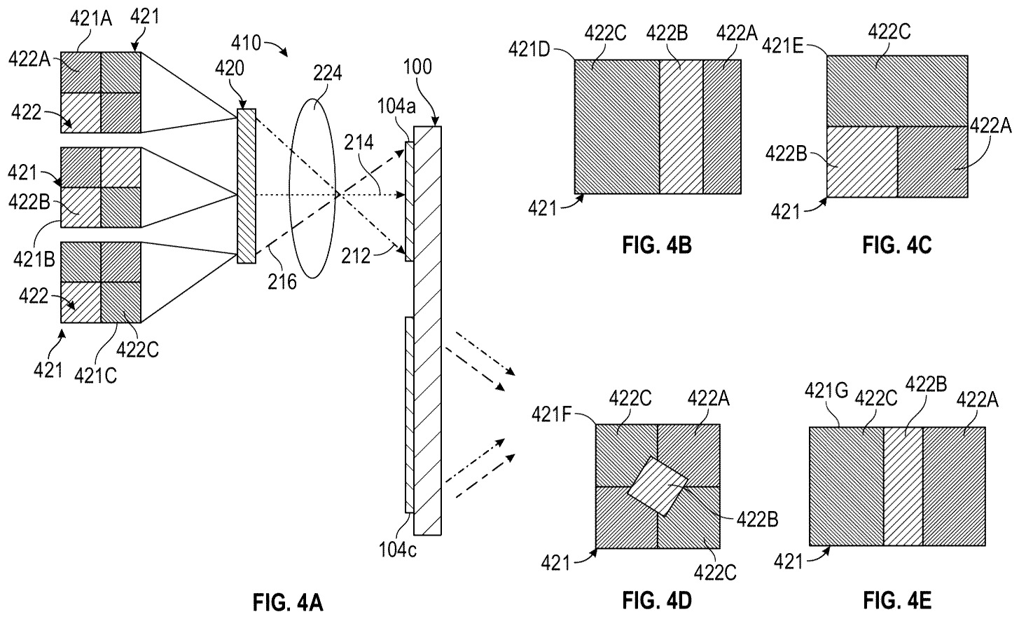

FIG. 4A illustrates a projection system 410 with a modified micro-light emitting diode (uLED) pixel 420. The projection system 410 may be part of an augmented reality (AR) system or a virtual reality (VR) system. The projection system 410 is configured to emit visible light (e.g., red light 212, green light 214, and blue light 216) from the modified uLED panel 420. The modified uLED panel 420 may include a plurality of modified pixels 421, such as a first modified pixel 421A, a second modified pixel 421B, and a third modified pixel 421C. Each modified pixel includes a plurality of modified sub-pixels 422. The modified sub-pixels 422 may include a red sub-pixel 422A, a green sub-pixel 422B, or a blue sub-pixel 422C.

The modified uLED panel 420 is configured to pre-compensate for a second color trend of an optical device 100 in order to reduce color non-uniformity. The light (e.g., the red light 212, the green light 214, and the blue light 216) emitted from the uLED panel 420 may be adjusted to form a first color trend. The light may be adjusted by changing the number, the size, or the positioning of the plurality of modified sub-pixels 422 within the modified pixels 421 of the uLED panel 420. For example, as shown in the illustrated embodiment of FIG. 4A, the first modified pixel 421A at a first end of the uLED panel 420 includes 2 red sub-pixels 422A, 1 green sub-pixel 422B, and 1 blue sub-pixel 422C while the third modified pixel 421C at a second end of the uLED panel 420 includes 2 blue sub-pixels 422C, 1 green sub-pixel 422B, and 1 red sub-pixel 422A. The second modified pixel 421B near a center of the uLED panel 420, meanwhile, includes 2 green sub-pixels 422B, 1 blue sub-pixel 422C, and 1 red sub-pixel 422A. By having 2 red sub-pixels 422A at the first end of the uLED panel 420 and 2 blue sub-pixels 422C at the second end of the uLED panel 420, a first color trend may be formed.

FIG. 4B illustrates a fourth modified pixel 421D. FIG. 4C illustrates a fifth modified pixel 421E. FIG. 4E illustrates a seventh modified pixel 421G. The red sub-pixel 422A may have a first area, the green sub-pixel 422B may have a second area, and the blue sub-pixel 422C may have a third area. The first area is different than the second area and the third area, and the second area is different from the third area. The variation in the area of the sub-pixels 422 of the uLED panel 420 may form the first color trend. In FIG. 4B, FIG. 4C, and FIG. 4E, the blue sub-pixel 422C has an area that is larger than the red sub-pixel 422A and the green sub-pixel 422B. In other embodiments, the red sub-pixel 422A may be larger than the blue sub-pixel 422C and the green sub-pixel 422B. The relative sizes of the sub-pixels 422 may form the first color trend.

FIG. 4D illustrates a sixth modified pixel 421F. The red sub-pixels 422A and the blue sub-pixels 422C are larger than the green sub-pixel 422B. The green sub-pixel 422B is centered on a quadripoint of the red sub-pixels 422A and the blue sub-pixels 422C. The variation in the position of the sub-pixels 422 of the uLED panel 420 may further form the first color trend.

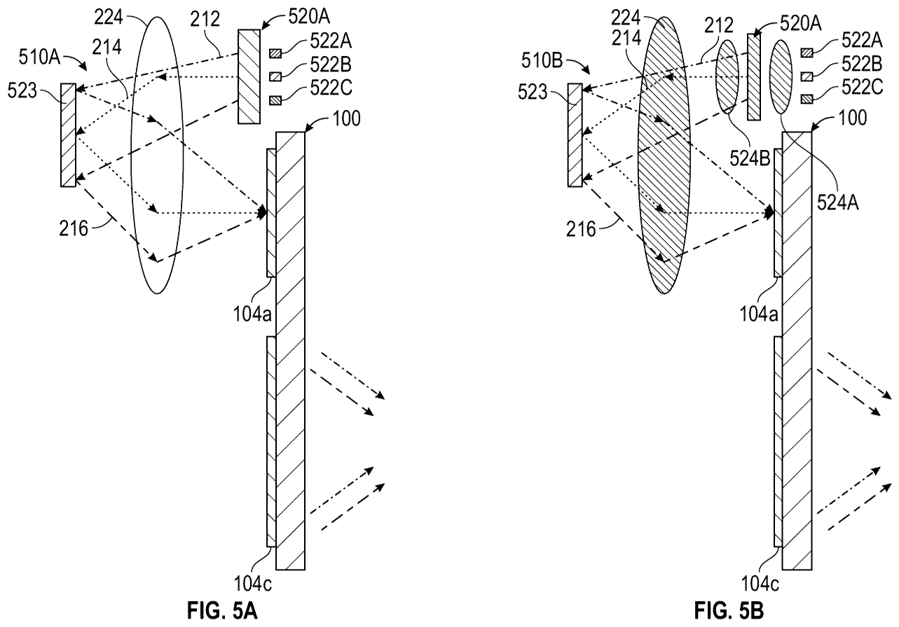

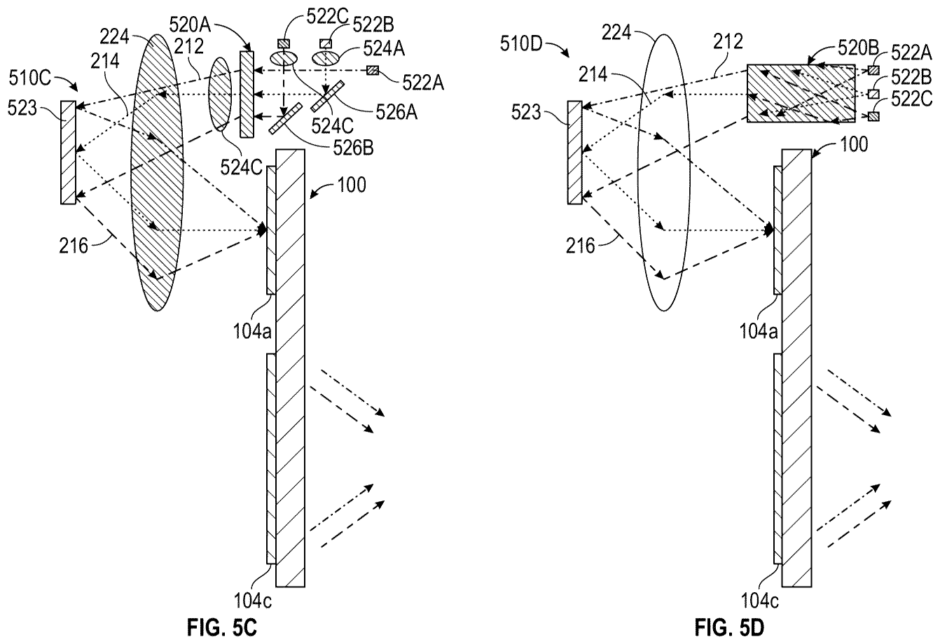

FIG. 5A illustrates a projection system 510A with a micro-lens array (MLA) system 520A. The projection system 510A may be part of an augmented reality (AR) system or a virtual reality (VR) system. The projection system 510A is configured to emit visible light (e.g., red light 212, green light 214, and blue light 216) from a red LED 522A, a green LED 522B, and blue LED 522C.

The projection system 510A further includes a lens 224 and a reflector 523. The MLA 520A is configured to pre-compensate for a second color trend of an optical device 100 in order to reduce color non-uniformity. The light (e.g., the red light 212, the green light 214, and the blue light 216) emitted from the red LED 522A, the green LED 522B, and the blue LED 522C may be adjusted by the MLA 520A to form a first color trend. By adjusting reflector 523 position, reflector 523 size, lens 224 position, and the lens 224 size, the light may be further adjusted to form the first color trend. The red LED 522A, the green LED 522B, and the blue LED 522C emit the light towards the MLA 520A, which is configured to adjust the light into the first color trend and focus the first color trend towards the lens 224. The lens 224 then focuses the first color trend toward the reflector 523. The reflected first color trend is directed back towards the lens 224, which is configured to focus the light of the first color trend towards the optical device 100. The first color trend may have, for example, more red light 212 on one side of the first trend and more blue light 216 on an opposite side of the first trend.

FIG. 5B illustrates a projection system 510B with the MLA system 520A and a first MLA lens 524A and a second MLA lens 524B. The projection system 510B may be part of an augmented reality (AR) system or a virtual reality (VR) system. The projection system 510B is configured to emit visible light (e.g., red light 212, green light 214, and blue light 216) from a red LED 522A, a green LED 522B, and blue LED 522C.

The projection system 510B further includes a lens 224 and a reflector 523. The MLA 520A is configured to pre-compensate for a second color trend of an optical device 100 in order to reduce color non-uniformity. The light (e.g., the red light 212, the green light 214, and the blue light 216) emitted from the red LED 522A, the green LED 522B, and the blue LED 522C may be adjusted by the MLA 520A to form a first color trend. By adjusting reflector 523 position, reflector 523 size, lens 224 position, and the lens 224 size, the light may be further adjusted to form the first color trend. The red LED 522A, the green LED 522B, and the blue LED 522C emit the light towards the first MLA lens 524A, which focuses the light toward the MLA 520A. The MLA 520A is configured to adjust the light into the first color trend and focus the first color trend towards the second MLA lens 524B. The second MLA lens 524B focuses the first color trend towards the lens 224. The lens 224 then focuses the first color trend toward the reflector 523. The reflected first color trend is directed back towards the lens 224, which is configured to focus the light of the first color trend towards the optical device 100. The first color trend may have, for example, more red light 212 on one side of the first trend and more blue light 216 on an opposite side of the first trend.

FIG. 5C illustrates a projection system 510C with the MLA system 520A, a first LED lens 524A, a second LED lens 524B, and a MLA lens 524C. The projection system 510C may be part of an augmented reality (AR) system or a virtual reality (VR) system. The projection system 510C is configured to emit visible light (e.g., red light 212, green light 214, and blue light 216) from a red LED 522A, a green LED 522B, and blue LED 522C.

The projection system 510C further includes a lens 224 and a reflector 523. The MLA 520A is configured to pre-compensate for a second color trend of an optical device 100 in order to reduce color non-uniformity. The light (e.g., the red light 212, the green light 214, and the blue light 216) emitted from the red LED 522A, the green LED 522B, and the blue LED 522C may be adjusted by the MLA 520A to form a first color trend. By adjusting reflector 523 position, reflector 523 size, lens 224 position, and the lens 224 size, the light may be further adjusted to form the first color trend. The red LED 522A, the green LED 522B, and the blue LED 522C emit the light towards the MLA 520A. The light emitted from the green LED 522B passes through the first LED lens 524A and the light emitted from the blue LED 522C passes through the second LED lens 524B. The first LED lens focuses the light towards a first LED reflector 526A and the second LED lens focuses the light towards a second LED reflector 526B. The first LED reflector 526A and the second LED reflector 526B direct the light toward the MLA 520A. In some embodiments, a third LED lens and third LED reflector are used to focus the light emitted from the red LED 522A toward the MLA 520A. The MLA is configured to adjust the light into the first color trend and focus the first color trend towards the lens 224. The lens 224 then focuses the first color trend toward the reflector 523. The reflected first color trend is directed back towards the lens 224, which is configured to focus the light of the first color trend towards the optical device 100. The first color trend may have, for example, more red light 212 on one side of the first trend and more blue light 216 on an opposite side of the first trend.

FIG. 5D illustrates a projection system 510D with a mixing rod system 520B. The projection system 510D may be part of an augmented reality (AR) system or a virtual reality (VR) system. The projection system 510D is configured to emit visible light (e.g., red light 212, green light 214, and blue light 216) from a red LED 522A, a green LED 522B, and blue LED 522C.

The projection system 510D further includes a lens 224 and a reflector 523. The mixing rod system 520B is configured to pre-compensate for a second color trend of an optical device 100 in order to reduce color non-uniformity. The light (e.g., the red light 212, the green light 214, and the blue light 216) emitted from the red LED 522A, the green LED 522B, and the blue LED 522C may be adjusted by the mixing rod system 520B to form a first color trend. By adjusting reflector 523 position, reflector 523 size, lens 224 position, and the lens 224 size, the light may be further adjusted to form the first color trend. The red LED 522A, the green LED 522B, and the blue LED 522C emit the light towards the mixing rod system 520B, which is configured to adjust the light into the first color trend and focus the first color trend towards the lens 224. The lens 224 then focuses the first color trend toward the reflector 523. The reflected first color trend is directed back towards the lens 224, which is configured to focus the light of the first color trend towards the optical device 100. The first color trend may have, for example, more red light 212 on one side of the first trend and more blue light 216 on an opposite side of the first trend.

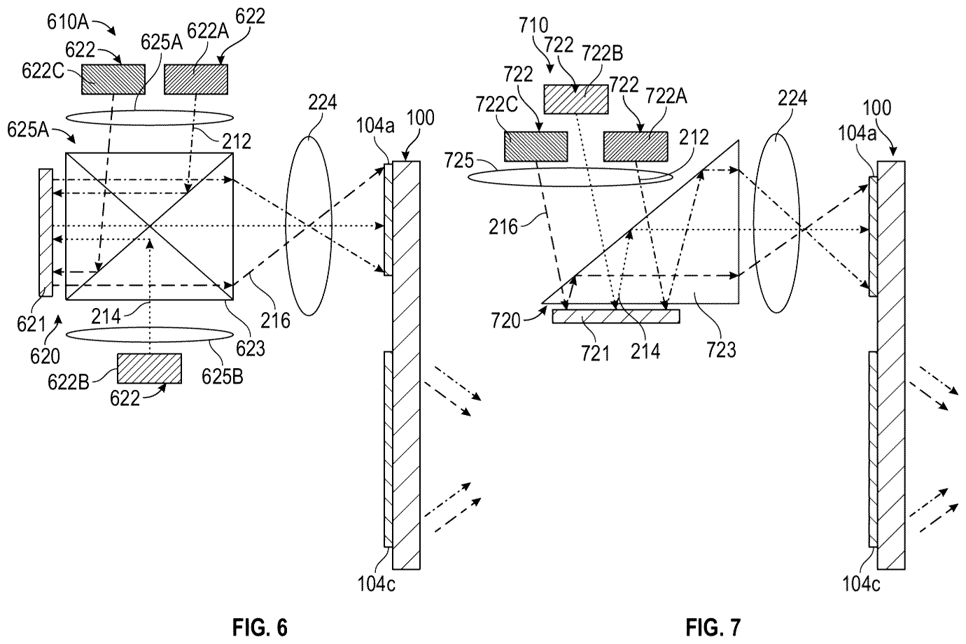

FIG. 6 illustrates a projection system 610 with a mini-LED system 620. The projection system 610 may be part of an augmented reality (AR) system or a virtual reality (VR) system. The projection system 610 includes the mini-LED system 620 and a lens 224. The projection system 610 is configured to emit visible light (e.g., red light 212, green light 214, and blue light 216) from the mini-LED system 620. The mini-LED system 620 may include a plurality of mini-LED arrays 622, such as a red mini-LED array 622A, a green mini-LED array 622B, or a blue mini-LED array 622C. The lens 224 is positioned between the mini-LED system 620 and the optical device 100.

The mini-LED system 620 further includes a beam splitter 623, a first array lens 625A, a second array lens 625B, and a LCOS 621. The mini-LED system 620 is configured to pre-compensate for a second color trend of an optical device 100 in order to reduce color non-uniformity. The light (e.g., the red light 212, the green light 214, and the blue light 216) emitted from the mini-LED arrays 622 (e.g., the red mini-LED array 622A, the green mini-LED array 622B, and the blue mini-LED array 622C, respectively) may be adjusted to form a first color trend. By adjusting the mini-LED array 622 position, mini-LED array 622 size, lens 224 position, and the lens 224 size, the mini-LED system 620 may form the first color trend. The mini-LED arrays 622 emit the light through the first array lens and second arrays lens towards the beam splitter 222 of the mini-LED system 620. In the illustrated embodiment, the red mini-LED array 622A and the blue mini-LED arrays 622C emit the red light 212 and the blue light 216, respectively, through the first array lens 625A, while the green mini-LED array 622B emits the green light 214 through the second array lens 625B. The first array lens 625A and the second array lens 625B focus the light emitted from the mini-LED arrays 622 towards the beam splitter 623. The beam splitter 623 splits or isolates the red light 212, the green light 214, and the blue light 216. In some embodiments, the beam splitter 623 may include a first beam splitter and a second beam splitter. The first beam splitter may split or isolate the red light 212 and the blue light 216. The second beam splitter may split or isolate the green light 214. The split or isolated red light 212, green light 214, and blue light 216 are directed towards the LCOS 621 to form the first color trend.

FIG. 7 illustrates a projection system 710 with a mini-LED system 720. The projection system 710 may be part of an augmented reality (AR) system or a virtual reality (VR) system. The projection system 710 includes the mini-LED system 720 and a lens 224. The projection system 710 is configured to emit visible light (e.g., red light 212, green light 214, and blue light 216) from the mini-LED system 720. The mini-LED system 720 may include a plurality of mini-LED arrays 722, such as a red mini-LED array 722A, a green mini-LED array 722B, or a blue mini-LED array 722C. The lens 224 is positioned between the mini-LED system 720 and the optical device 100.

The mini-LED system 720 further includes a beam splitter 723, an array lens 725, and a DLP 721. The projection system 710 is configured to pre-compensate for the second color trend of an optical device 100 in order to reduce color non-uniformity. The light (e.g., the red light 212, the green light 214, and the blue light 216) emitted from the mini-LED arrays 722 (e.g., the red mini-LED array 722A, the green mini-LED array 722B, and the blue mini-LED array 722C, respectively) may be adjusted (i.e., a first dispersion of light) to form a first color trend. By adjusting the mini-LED arrays 722 position, mini-LED arrays 722 size, lens 224 position, and the lens 224 size, the mini-LED system 720 may form the first color trend. The mini-LED arrays 722 emits the light towards the beam splitter 723 of the mini-LED system 720 through an array lens 725. The array lens 725 focuses the light emitted from the mini-LED arrays 722 towards the beam splitter 723. The beam splitter 723 splits or isolates the red light 212, the green light 214, and the blue light 216. The split or isolated red light 212, green light 214, and blue light 216 are directed towards the DLP 721 to form the first color trend. The light of the first color trend is directed towards the lens 224, which is configured to focus the light of the first color trend towards the optical device 100.

Accordingly, the embodiments described above in conjunction with FIGS. 2-7 enable the first color trend to have, for example, more red light 212 on one side of the first color trend and more blue light 216 on an opposite side of the first color trend. The first color trend of an illumination system (e.g., modified micro-light emitting diode (uLED) panel, a liquid crystal on silicon (LCOS) illumination engine, digital light processing (DLP) system, a micro-lens array (MLA), or a plurality of micro-LED arrays) may be the inverse of the second color trend of the optical device 100 (e.g., the first color trend and the second color trend may destructively interfere and partially or substantially cancel each other out to form the propagated light), thereby compensating for the global color shift of the optical device 100. More specifically, a first dispersion of light emitted from the illumination system at least partially cancels out a second dispersion of light of the optical device 100. By compensating for the global color shift of the optical device 100, the embodiments may improve the global color uniformity, simplify the optical device 100 design and fabrication, and increase optical device efficiency. Further, by reducing the burden on the optical device 100 to compensate for color non-uniformity, the optical device can be optimized to increase efficiency.

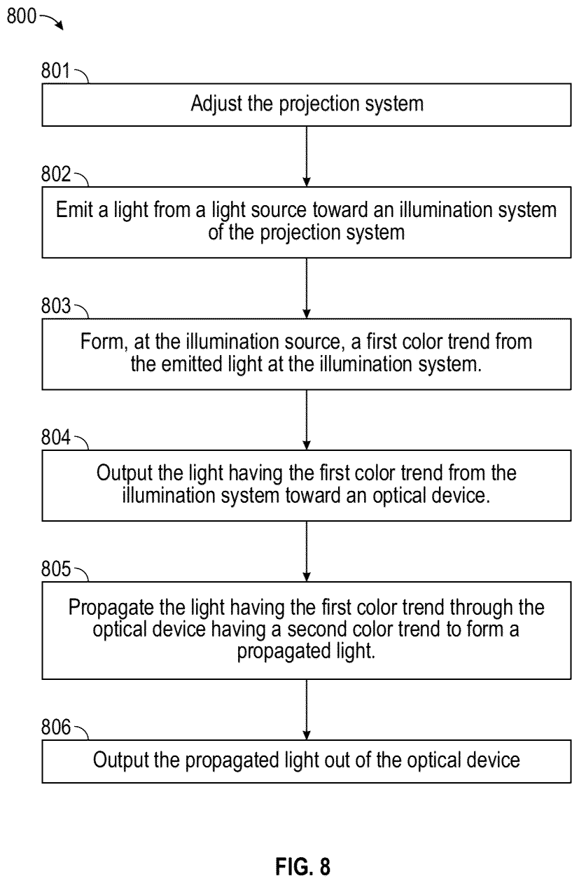

FIG. 8 illustrates a method 800 of using projection system 210, 310, 410, 510A, 510B, 510C, 510D, 610, or 710. At operation 801, the projection system 210, 310, 410, 510A, 510B, 510C, 510D, 610, or 710 is adjusted. The projection system 210, 310, 410, 510A, 510B, 510C, 510D, 610, or 710 may be adjusted by adjusting a RGB backlight and/or a one or more lenses of the projection system 210, 310, 410, 510A, 510B, 510C, 510D, 610, or 710. The RGB backlight may include discrete red, green, and blue LEDs, red, green, and blue mini-LED arrays, or micro-LEDs including red, green, and blue sub-pixels. The RGB backlight may be adjusted with respect to the position of the RGB backlight in regard to an illumination system and the size of the RGB backlight. The one or more lenses may include a lens 224 and a one or more arrays lenses. The one or more arrays lenses may be positioned between the RGB backlight and the illumination system. For example, the RGB backlight may include a red, green and blue mini-LEDs, and the arrays of lenses may be positioned between the red, green and blue mini-LEDs and the illumination system. The lens 224 is positioned between the illumination system and an optical device 100. The illumination system may include a liquid crystal on silicon (LCOS) illumination engine 220, a digital light processing system 320, a modified uLED panel 420, a micro-lens array (MLA) 520, a mini-LED system 620 including a LCOS 621, or a mini-LED system 720 including a DLP 721.

At operation 802, the RGB backlight emits a light towards the illumination system. The light may include a red light 212, a green light 214, and a blue light 216. In some embodiments, the light propagates through an array lens to focus the emitted light towards the illumination system. In other embodiments, a plurality of array lenses (e.g., a first array lens and a second array lens) focus the emitted light towards the illumination system.

At operation 803, the illumination system forms a first color trend from the emitted light. The first color trend may be formed by a dispersion of the emitted light by the illumination system. The light emitted towards the illumination system is directed towards the illumination system device. The illumination system device may include a DLP, a LCOS, or a MLA. In some embodiments, the illumination system may include a beam splitter. The beam splitter is configured to split or isolate the light emitted from the RGB backlight. The emitted light is directed from the RGB backlight (or, in some embodiments, the beam splitter) towards the illumination system device.

At operation 804, the first color trend is propagated from the illumination system device towards an optical device 100. In some embodiments, the first color trend may pass through a lens 224. In other embodiments, the first color trend may pass through the lens 224, reflect off a reflector 523, and pass through the lens 224 a second time. The lens 224 is configured to focus the first color trend towards the optical device 100.

At operation 805, the first color trend is propagated through the optical device 100 to form a propagated light. Light propagating through the optical device 100 has a second color trend. The second color trend may be formed by a second dispersion of light (e.g., a dispersion of the propagated light) by the optical device. The first color trend and the second color trend may be opposite one another (e.g., the first color trend and the second color trend may destructively interfere and partially or substantially cancel each other out to form the propagated light). The destructive interference of the first color trend and the second color trend decreases the color non-uniformity of the image produced by the optical device 100.

At operation 806, the propagated light is propagated out of the optical device 100, such as towards an eye of a user.

In summary, a projection system is disclosed to compensate for color non-uniformity in optical devices. The projection system includes a backlight, a lens, and an illumination system. The illumination system may be one of a modified micro-light emitting diode (uLED) panel, a liquid crystal on silicon (LCOS) illumination engine, digital light processing (DLP) system, a micro-lens array (MLA), or a plurality of micro-LED arrays. A first color trend of an illumination system may be the inverse of the second color trend of the optical device, thereby compensating for the global color shift of the optical device. By compensating for the global color shift of the optical device, the embodiments may improve the global color uniformity, simplify the optical device design and fabrication, and increase optical device efficiency. Further, by reducing the burden on the optical device to compensate for color non-uniformity, the optical device can be optimized to increase efficiency.

While the foregoing is directed to embodiments of the present disclosure, other and further embodiments of the disclosure may be devised without departing from the basic scope thereof, and the scope thereof is determined by the claims that follow.

What is claimed is:

1. A projection system comprising:
a backlight;
a lens; and
an illumination system configured to receive light from the backlight and emit light having a first color trend through the lens towards an optical device, wherein the first color trend at least partially cancels out a second color trend of the optical device.

2. The projection system of claim 1, wherein the illumination system includes a modified micro-light emitting diode (uLED) panel, wherein the modified uLED panel comprises:
a plurality of modified pixels, each modified pixel comprising a plurality of sub-pixels, the sub-pixels comprising:
a red sub-pixel having a first area;
a green sub-pixel having a second area; and
a blue sub-pixel having a third area, wherein the first area is different from the third area to form the first color trend.

3. The projection system of claim 1, wherein the illumination system comprises a liquid crystal on silicon (LCOS) illumination engine, and a beam splitter, wherein the LCOS illumination engine forms the first color trend.

4. The projection system of claim 1, wherein the illumination system comprises a digital light processing (DLP) system, and a beam splitter, wherein the DLP system forms the first color trend.

5. The projection system of claim 1, wherein the illumination system comprises a micro-lens array (MLA), and a reflector, wherein the MLA forms the first color trend.

6. The projection system of claim 1, wherein the backlight comprises a red LED, a blue LED, and a green LED.

7. The projection system of claim 1, wherein the backlight comprises a red mini-LED array, a blue mini-LED array, and a green mini-LED array.

8. An augmented reality (AR) system comprising:
a projection system comprising:
a backlight;
a lens; and
an illumination system configured to receive light from the backlight and emit the light through the lens towards an optical device; and
an optical device configured to emit the light, wherein a first dispersion of light produced by the illumination system at least partially cancels out a second dispersion of light of the optical device.

9. The AR system of claim 8, wherein the illumination system includes a modified micro-light emitting diode (uLED) pixel, wherein the modified uLED panel comprises:
a plurality of modified pixels, each sub-pixel comprising a plurality of sub-pixels, the sub-pixels comprising:
a red sub-pixel having a first area;
a green sub-pixel having a second area; and
a blue sub-pixel having a third area, wherein the first area is different from the third area to form the first dispersion of light.

10. The AR system of claim 8, wherein the illumination system comprises a liquid crystal on silicon (LCOS) illumination engine, a beam splitter, and a lens, wherein the LCOS illumination engine forms the first dispersion of light.

11. The AR system of claim 8, wherein the illumination system comprises a DLP, a beam splitter, and a lens, wherein the DLP forms the first dispersion of light.

12. The AR system of claim 8, wherein the illumination system comprises a micro-lens array (MLA), a lens, and a reflector, wherein the MLA forms the first dispersion of light.

13. The AR system of claim 8, wherein the backlight comprises a red LED, a blue LED, and a green LED.

14. The AR system of claim 8, wherein the backlight comprises a red mini-LED array, a blue mini-LED array, and a green mini-LED array.

15. A method of using an augmented reality (AR) system comprising:
emitting a light from a light source toward an illumination system of a projection system;
forming, at the illumination system, light having a first color trend;
outputting the light having the first color trend from the illumination system toward an optical device;
propagating the first color trend through the optical device having a second color trend to form a propagated light; and
outputting the propagated light from the optical device toward a user's eye.

16. The method of claim 15, wherein the illumination system comprises a liquid crystal on silicon (LCOS) illumination engine, a beam splitter, and a lens, wherein the LCOS illumination engine forms the first color trend.

17. The method of claim 15, wherein the illumination system comprises a DLP, a beam splitter, and a lens, wherein the DLP forms the first color trend.

18. The method of claim 15, wherein the illumination system comprises a micro-lens array (MLA), a lens, and a reflector, wherein the MLA forms the first color trend.

19. The method of claim 15, wherein the light source includes modified micro-light emitting diode (uLED) pixel, each modified uLED panel comprising a pixel comprising:
a red sub-pixel having a first area,
a green sub-pixel having a second area; and
a blue sub-pixel having a third area.

20. The method of claim 19, wherein adjusting the projection system includes adjusting a size of the first area, a size of the second area, and a size of the third area to form the first color trend.
